(19) United States
(12) Patent Application Publication
(10) Pub. No.: US 2015/0095191 A1
(43) Pub. Date: Apr. 2, 2015

(54) GLOBAL MERCHANT NETWORK

(71) Applicant: Amazon Technologies, Inc., Reno, NV (US)

(72) Inventor: Haijun Hu, Seattle, WA (US)

(73) Assignee: Amazon Technologies, Inc., Reno, NV (US)

(21) Appl. No.: 14/219,733

(22) Filed: Mar. 19, 2014

Related U.S. Application Data
(60) Provisional application No. 61/884,791, filed on Sep. 30, 2013.

(51) Int. Cl. G06Q 30/06

(52) U.S. Cl. CPC G06Q 30/0635; G06Q 30/0613
USPC 705/26.41

(57) ABSTRACT

Techniques for providing a global merchant network are provided. In some embodiments, a global merchant network can be established for enabling items offered in a first geographic region by one party to be offered in a different geographic region by a different party. For example, the global merchant network may facilitate or otherwise enable two merchants associated with two different marketplaces (e.g., different electronic marketplaces that service different geographic regions) to provide items from one marketplace to another.

### CROSS REFERENCE TO RELATED APPLICATIONS

The present application is a non-provisional patent application of U.S. Provisional Application No. 61/884,791, entitled “Global Seller Community,” filed on Sep. 30, 2013, which is incorporated herein by reference in its entirety for all purposes.

### BACKGROUND

Merchants exist all over the world. Merchants offer items from local sources, including items that the merchant manufactures or from dedicated manufacturers that are relatively close to the merchant. However, inventory is limited for some merchants. The supply of items is especially limited for merchants that are located in remote geographic regions.

It is also difficult to provide items to merchants, due to constraints placed on providing items. For example, constraints may be imposed by governmental entities that require certain information in order to ship to a non-local customer. This process is a hassle to figure out, especially for merchants who do not specialize in the selling process for different geographic regions.

### BRIEF DESCRIPTION OF THE DRAWINGS

Various embodiments in accordance with the present disclosure will be described with reference to the drawings, in which:

FIG. 1 illustrates an illustrative flow for offering an item described herein, according to at least one example;

FIG. 2 illustrates an example architecture for offering an item described herein that includes an item management system and/or user devices connected via one or more networks, according to at least one example;

FIG. 3 illustrates an example graphical user interface for requesting an item, according to at least one example;

FIG. 4 illustrates an example graphical user interface for fulfilling an item, according to at least one example;

FIG. 5 illustrates an example flow diagram for determining when to offer an item, according to at least one example;

FIG. 6 illustrates an example flow diagram for providing a global merchant network, according to at least one example;

FIG. 7 illustrates an example flow diagram for providing a global merchant network, according to at least one example;

FIG. 8 illustrates an example flow diagram for providing a global merchant network, according to at least one example;

FIG. 9 illustrates an example flow diagram for providing a global merchant network, according to at least one example;

FIG. 10 illustrates an example flow diagram for providing a global merchant network, according to at least one example; and

FIG. 11 illustrates an environment in which various embodiments of providing a global merchant network described herein can be implemented, according to at least one example.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Embodiments of the present disclosure are directed to, among other things, a service for enabling items offered in a first geographic region by one party to be offered in a different geographic region by a different party. The service may provide a global merchant network. For example, the service may facilitate or otherwise enable two merchants associated with two different marketplaces (e.g., different electronic marketplaces that service different geographic regions) to provide items from one marketplace to another. In some examples, the item may be requested from one of the merchants based at least in part on the fact that the item is not currently available in the local market of the requesting merchant. For example, an item that cannot be accessed in one country may be more popular and garner greater value in that country because of the lack of supply. As such, a merchant in that country may want to acquire the item from a merchant of a country where the item is available. In some examples, the service may be configured to facilitate the item being provided by providing fulfillment services and/or determinations of which items are appropriate (e.g., whether items comply with a set of standards, whether they are available to provide to other areas, etc.).

In a non-limiting example, a local merchant in Indian may want a wider selection of items to offer to customers in India and one or more local merchants of other countries (e.g., item providers in a Chinese marketplace) may want to increase their offerings and/or find additional channels to provide the items. As such, the local Indian merchant may be able to offer some of the items from the other local merchant to local customers in India. The orders for these items (e.g., from the local Indian customers) may be fulfilled from a Chinese fulfillment center to an Indian fulfillment center, which in turn can provide the item directly to the Indian customer's home. For example, once the Indian customer places the order with the local Indian merchant, the service can assist the local Indian merchant in obtaining (e.g., purchasing, transferring, shipping, trading, etc.) the product from the other local merchant and fulfilling the product from a local or global fulfillment center to the Indian customer's home. Additionally, the service may be able to connect other different local merchants (e.g., in the United States or elsewhere) with the local Indian merchant by identifying qualified local Indian merchants (e.g., an experienced Indian merchant with a good reputation.). In some examples, the connection between the local merchants of different countries may be based at least in part on trade regulations, item compatibility, taxes, configurations, or settings of the local merchants themselves.

In an embodiment, the local merchant may be a seller, entity that offers items, user, item provider, or other entity (e.g., “local merchant”) located in a first geographic region, including India, China, Europe, or other geographic region. The local merchant may want to offer items provided by a local merchant of a different country or a global merchant located in another geographic location. In an embodiment, the global merchant may be located in a second geographic region, including the United States, India, China, Europe, or other geographic region that is different from the first geographic region. In some embodiments, a set of users in the first geographic region can speak a first language and a different set of users in the second geographic region can speak a second language (e.g., English vs. Mandarin vs. Hindi). The global merchant may be a seller, entity that offers items, merchant, user, item provider, or other entity (e.g., “global merchant”) that wants items in its inventory offered in regions outside of the second geographic region.

The items may be offered to a local customer or user. In an embodiment, the local user may be a customer that can obtain items from the local merchant. In some examples, items may be obtained from the local merchant instead of the global merchant for customer service and/or user experience reasons. For example, customer service may be preferred by local customers with a local merchant, because local customer service can provide a live chat, can speak the local language, and/or may be available during substantially similar times or time zones of the local population. In another example, when a customer would like to return an item, a return to a local merchant may be easier than understanding international shipping rules and rates.

In another example, items may be provided as network content via a network interface (e.g., a web page or the like) for viewing, reviewing, selecting, ordering, etc. Additionally, local marketplaces may have access to purchase history or other customer information that global services may not. As such, items in a local marketplace may be placed higher (e.g., in search results) on a local version of marketplace-related network content. Thus, in some examples, network content of an item from a *.cn address may appear higher in search results in China than the same network content from a *.com address.

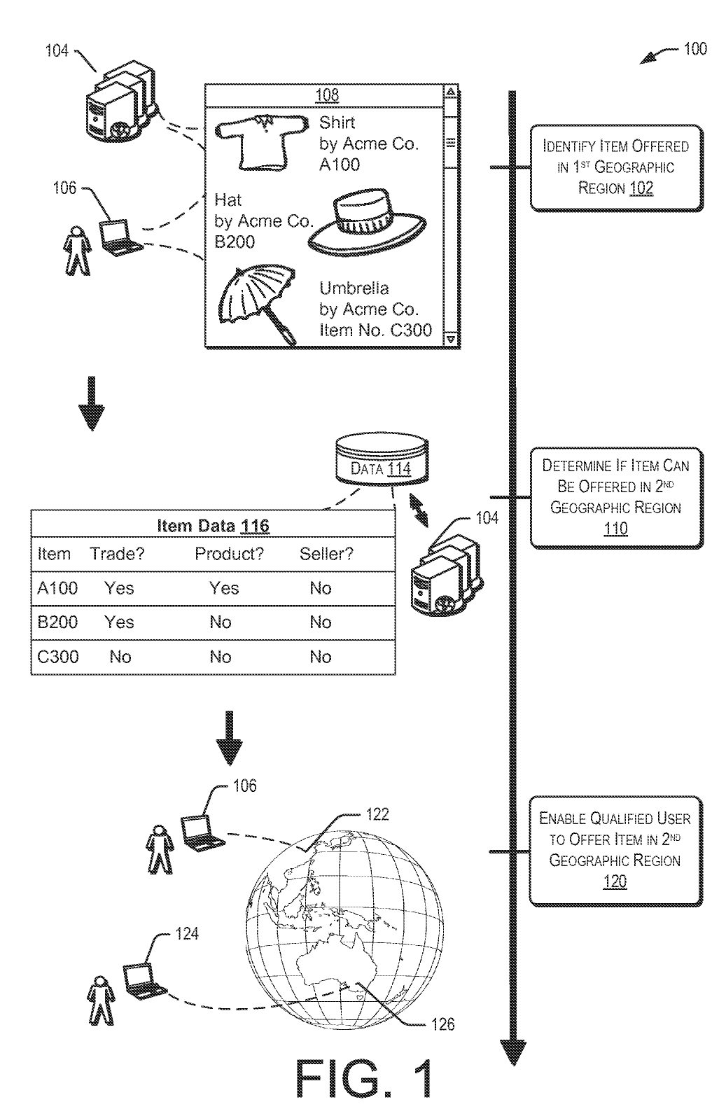

FIG. 1 illustrates an illustrative flow for offering an item described herein, according to at least one example. The method 100 may begin with identifying at least one item offered in a first geographic region 102. A service associated with one or more service provider computers 104 may help a merchant offer one or more items. In some examples, the items may be offered by advertising or displaying electronic representations of the items as network content 108. These items can represent a plurality of items that may be associated with item identifiers (e.g., A100, B200, C300). In an embodiment, the method 100 may identify a plurality of items available in a first electronic marketplace.

In an embodiment, the merchant in the first geographic region (e.g., the global merchant) may register, volunteer, or opt-in to provide items in a second geographic region. For example, the global merchant can log in to a network page to access a management computer (e.g., the service provider computers 104) that connects merchants with other merchants (e.g., a global merchant community or global merchant network). The management computer may help allow the global merchant located in a first geographic region to offer one or more items in a second geographic region through the user of a local merchant.

In an embodiment, the merchant in the first geographic region and the merchant in the second geographic region may each be associated with fulfillment and/or distribution services. In an embodiment, the fulfillment and/or distribution services may be unique for each geographic region or may interact with other services in order to provide an item to various geographic regions.

The method 100 may determine when an item is eligible and/or appropriate to be offered in a second geographic region 110. The service provider computers 104 can interact with a data store 114 that at least in part contains item data 116. The item data 116 may include item identifiers (e.g., A100, B200, C300), descriptions of items (e.g., shirt, hat, umbrella), other item information (e.g., price, dimensions), or whether the item is eligible to be offered to a different geographic region (e.g., trade or legal compliant, product compliant, already offered in the second geographic region, merchant compliant, or any other compliance standards).

The item data 116 may identify which items are able to be provided in a particular geographic region or through a particular electronic marketplace based on the item's compliance with one or more standards. For example, whether an item is trade or legal compliant may be based at least in part on import/export laws of the two geographic regions in question. In another example, whether an item is product compliant may be based at least in part on standards employed in the two geographic regions (e.g., a 110 V standard may be used in one country, while a 220 V standard may be used the other country, which can cause the item not to be product compliant with the local merchant's geographic region).

In an embodiment, the merchant may identify criteria associated with the item. For example, the criteria may identify other users of the second geographic region to whom the merchant is willing to offer the item. In another example, the system may ask the merchant which entities can provide the item, establish a cost limit when the item is provided to the customer, specify a threshold associated with a rating (e.g., quality of a merchant, level of customer service, number of feedback messages, merchant rating, etc.), determine which types of entities may provide the item, or other criteria.

In an embodiment, the item data may help filter the plurality of items to identify one or more items that may be eligible to be offered in the second geographic area. For example, the method 100 may determine that an item is not already offered in the second geographic region before the item can be offered by the local merchant. In another example, the method 100 may determine that the item is not legally allowed to be imported to a particular country (e.g., not trade compliant).

The method 100 may enable a qualified user to offer the item in the second geographic region 120. For example, the global merchant 106 may be located in a first geography 122 while the local merchant 124 may be located in a second geography 126. The local merchant 124 can offer one or more items to local customers that are currently associated with the global merchant (e.g., stored in a fulfillment center associated with the global merchant).

In an embodiment, the local merchant may be a high-volume local merchant. For example, a local merchant may be able to negotiate a better price for one or more items, conduct a multi-level deal to provide items to the local geographic region, participate in business-to-business transactions, order more than one item at a time (e.g., a shipping container full of items), or other negotiations. It may be beneficial to provide more than one item at a time in part in order to reduce the amount of time needed to fulfill the item (e.g., storing the items at the local fulfillment center) or submit the items through U.S. Customs (or other regulatory entities) before the item is ordered by the local customer.

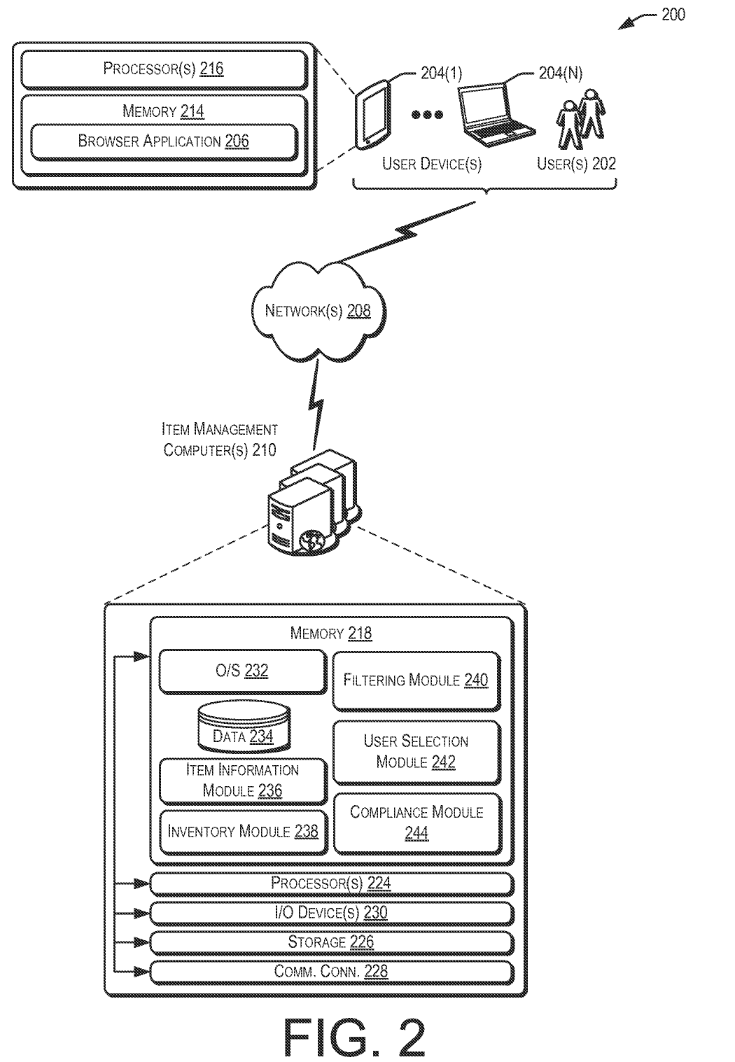

FIG. 2 illustrates an example architecture for offering an item described herein that includes an item management system and/or user devices connected via one or more networks, according to at least one example. In architecture 200, one or more users 202 (i.e., web browser users) may utilize user computing devices 204(1)-(N) (collectively, user devices 204) to access an application 206 (e.g., a web browser), via one or more networks 208. In some aspects, the application 206 may be hosted, managed, and/or provided by a computing resources service or service provider, such as by utilizing one or more service provider computers and/or one or more item management computers 210. The one or more item management computers 210 may, in some examples, provide computing resources such as, but not limited to, client entities, low latency data storage, durable data storage, data access, management, virtualization, cloud-based software solutions, electronic content performance management, etc. The one or more item management computers 210 may also be operable to provide web hosting, computer application development, and/or implementation platforms, combinations of the foregoing, or the like to the one or more users 202. The one or more item management computers 210, in some examples, may enable a local merchant to provide items from geographic regions outside of its local geographic region.

In some examples, the networks 208 may include any one or a combination of many different types of networks, such as cable networks, the Internet, wireless networks, cellular networks and other private and/or public networks. While the illustrated example represents the users 202 accessing the application 206 over the networks 208, the described techniques may equally apply in instances where the users 202 interact with the item management computers 210 via the one or more user devices 204 over a landline phone, via a kiosk, or in any other manner. It is also noted that the described techniques may apply in other client/server arrangements (e.g., set-top boxes, etc.), as well as in non-client/server arrangements (e.g., locally stored applications, etc.).

As described briefly above, the application 206 may allow the users 202 to interact with a service provider computer, such as to access web content (e.g., web pages, music, video, etc.). The one or more item management computers 210, perhaps arranged in a cluster of servers or as a server farm, may host the application 206 and/or cloud-based software services. Other server architectures may also be used to host the application 206. The application 206 may be capable of handling requests from many users 202 and serving, in response, various item web pages. The application 206 can provide any type of website that supports user interaction, including social networking sites, online retailers, informational sites, blog sites, search engine sites, news and entertainment sites, and so forth. As discussed above, the described techniques can similarly be implemented outside of the application 206, such as with other applications running on the user devices 204.

The user devices 204 may be any type of computing device such as, but not limited to, a mobile phone, a smart phone, a personal digital assistant (PDA), a laptop computer, a desktop computer, a thin-client device, a tablet PC, an electronic book (e-book) reader, etc. In some examples, the user devices 204 may be in communication with the item management computers 210 via the networks 208, or via other network connections. Additionally, the user devices 204 may be part of the distributed system managed by, controlled by, or otherwise part of the item management computers 210 (e.g., a console device integrated with the item management computers 210).

In one illustrative configuration, the user devices 204 may include at least one memory 214 and one or more processing units (or processor(s)) 216. The processor(s) 216 may be implemented as appropriate in hardware, computer-executable instructions, firmware, or combinations thereof. Computer-executable instruction or firmware implementations of the processor(s) 216 may include computer-executable or machine-executable instructions written in any suitable programming language to perform the various functions described. The user devices 204 may also include geo-location devices (e.g., a global positioning system (GPS) device or the like) for providing and/or recording geographic location information associated with the user devices 204.

The memory 214 may store program instructions that are loadable and executable on the processor(s) 216, as well as data generated during the execution of these programs. Depending on the configuration and type of user device 204, the memory 214 may be volatile (such as random access memory (RAM)) and/or non-volatile (such as read-only memory (ROM), flash memory, etc.). The user device 204 may also include additional removable storage and/or non-removable storage including, but not limited to, magnetic storage, optical disks, and/or tape storage. The disk drives and their associated computer-readable media may provide non-volatile storage of computer-readable instructions, data structures, program modules, and other data for the computing devices. In some implementations, the memory 214 may include multiple different types of memory, such as static random access memory (SRAM), dynamic random access memory (DRAM), or ROM.

Turning to the contents of the memory 214 in more detail, the memory 214 may include an operating system and one or more application programs or services for implementing the features disclosed herein including at least the recommended item, such as via the browser application 206 or dedicated applications (e.g., smart phone applications, tablet applications, etc.). The browser application 206 may be configured to receive, store, and/or display a website or other interface for interacting with the item management computers 210. Additionally, the memory 214 may store access credentials and/or other user information such as, but not limited to, user IDs, passwords, and/or other user information. In some examples, the user information may include information for authenticating an account access request such as, but not limited to, a device ID, a cookie, an IP address, a location, or the like. In addition, the user information may include a user 202 provided response to a security question or a geographic location obtained by the user device 204.

In some aspects, the item management computers 210 may also be any type of computing devices such as, but not limited to, a mobile phone, a smart phone, a personal digital assistant (PDA), a laptop computer, a desktop computer, a server computer, a thin-client device, a tablet PC, etc. Additionally, it should be noted that in some embodiments, the service provider computers are executed by one more virtual machines implemented in a hosted computing environment. The hosted computing environment may include one or more rapidly provisioned and released computing resources, which computing resources may include computing, networking and/or storage devices. A hosted computing environment may also be referred to as a cloud computing environment. In some examples, the item management computers 210 may be in communication with the user devices 204 and/or other service providers via the networks 208, or via other network connections. The item management computers 210 may include one or more servers, perhaps arranged in a cluster, as a server farm, or as individual servers not associated with one another. These servers may be configured to implement the content performance management described herein as part of an integrated, distributed computing environment.

In one illustrative configuration, the item management computers 210 may include at least one memory 218 and one or more processing units (or processor(s)) 224. The processor(s) 224 may be implemented as appropriate in hardware, computer-executable instructions, firmware, or combinations thereof. Computer-executable instruction or firmware implementations of the processor(s) 224 may include computer-executable or machine-executable instructions written in any suitable programming language to perform the various functions described.

The memory 218 may store program instructions that are loadable and executable on the processor(s) 224, as well as data generated during the execution of these programs. Depending on the configuration and type of item management computers 210, the memory 218 may be volatile (such as RAM) and/or non-volatile (such as ROM, flash memory, etc.). The item management computers 210 or servers may also include additional storage 226, which may include removable storage and/or non-removable storage. The additional storage 226 may include, but is not limited to, magnetic storage, optical disks and/or tape storage. The disk drives and their associated computer-readable media may provide non-volatile storage of computer-readable instructions, data structures, program modules, and other data for the computing devices. In some implementations, the memory 218 may include multiple different types of memory, such as SRAM, DRAM, or ROM.

The memory 218, the additional storage 226, both removable and non-removable, are all examples of computer-readable storage media. For example, computer-readable storage media may include volatile or non-volatile, removable or non-removable media implemented in any method or technology for storage of information such as computer-readable instructions, data structures, program modules, or other data. The memory 218 and the additional storage 226 are all examples of computer storage media. Additional types of computer storage media that may be present in the item management computers 210 may include, but are not limited to, PRAM, SRAM, DRAM, RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by the item management computers 210. Combinations of any of the above should also be included within the scope of computer-readable media.

Alternatively, computer-readable communication media may include computer-readable instructions, program modules, or other data transmitted within a data signal, such as a carrier wave, or other transmission. However, as used herein, computer-readable storage media does not include computer-readable communication media.

The item management computers 210 may also contain communications connection(s) 228 that allow the item management computers 210 to communicate with a stored database, another computing device or server, user terminals and/or other devices on the networks 208. The item management computers 210 may also include I/O device(s) 230, such as a keyboard, a mouse, a pen, a voice input device, a touch input device, a display, speakers, a printer, etc.

Turning to the contents of the memory 218 in more detail, the memory 218 may include an operating system 232, one or more data stores 234, and/or one or more application programs or services for implementing the features disclosed herein including an item information module 236, an inventory module 238, a filtering module 240, a user selection module 242, and/or a compliance module 244. In some examples, the item information module 236 may be configured to receive information associated with an item. Information may include an item identifier, description of an item, price, or other relevant information. In an embodiment, the item information may be used in part to determine whether an item may be offered by a local merchant or eligible to be offered in a local market.

The item information module 236 may also be configured to calculate an appropriate price for a geographic region. For example, the price may include the wholesale price, the cost to purchase the item from the global merchant, international shipping costs, delivery or freight costs, import duty, taxes, or other relevant information. The price may also factor in a local merchant's mark-up to provide the item to the local market. In an embodiment, the local merchant or local customer may be provided with this information.

The item information module 236 may also be configured to automatically update the price. For example, a first price can be identified for a first marketplace (e.g., for a first geographic region). An identification of a change of price can be received (e.g., in a request to change the price from a global merchant associated with the first marketplace). The item information module 236 may also be configured to receive the request and automatically update corresponding prices, including a second price of the first item in the second marketplace.

The item information module 236 may also be configured to calculate profit for an item. The profit can vary by geographic region. For example, the item information module 236 may also be configured to calculate the profit for the first geographic region, compare the profit between multiple geographic regions, suggest a price for providing the item based on a particular profit, alter the price in order to receive a particular profit, or determine a profitability associated with providing one or more items in a particular electronic marketplace.

The item information module 236 may also be configured to provide an order estimate. The order estimate may include one more items that are eligible to be provided by local merchants. The order estimate may be presented to at least a subset of merchants. For example, the item information module 236 may enable at least one of the subset of qualified merchants to offer the item to a local customer when at least one of the merchants accepts the order estimate. In an embodiment, the order estimate may comprise other information. For example, the order estimate may include a cost of the item from the provider of the item, a customs expense, a shipping expense, or a tax associated with providing the item from the first geographic region to the second geographic region.

The item information module 236 may also be configured to provide metrics to show a sales trend or other information associated with providing an item. For example, the metrics can be provided in reports, graphs, or other methods of providing metrics. The metrics may help identify an appropriate price for an item, suggested profitability for providing the item in a marketplace or geographic region, new items that a local merchant should acquire and offer in a particular geographic region, or other information.

The memory 218 may also include an inventory module 238. The inventory module 238 may be configured to provide information associated with one or more items stored with a first fulfillment service associated with a global merchant. In some examples, the inventor module 238 can identify one or more items that are available to provide to a local merchant from the global merchant.

The inventory module 238 may also be configured to provide information associated with one or more items already ordered and/or stored in a second fulfillment service associated with a local merchant. For example, a different merchant may have previously ordered these items, a global merchant could have provided these items previously, or the items may have been returned and remain in the second fulfillment center.

The inventory module 238 may also be configured to manage a return of an item. For example, the item may have been provided from a first geographic region to a second geographic region. To return the item, the item may be provided from the second geographic region to the first geographic region. The inventory module 238 may be configured to return the item to the first geographic region when at least one of the customers of the second geographic region requests to return the item.

The inventory module 238 may also be configured to offer the item to the customer based at least in part on providing instructions to the first fulfillment center in the first geographic region to ship the item to the second fulfillment center in the second geographic region.

The inventory module 238 may also be configured to provide instructions to the second fulfillment center to ship the item to a purchaser of the item at least in response to an order fulfillment request from at least one of the merchants in the second geographic region. The inventory module 238 may also be configured to provide instructions to the second fulfillment center to ship the item to at least one of the merchants in the second geographic region at least in response to an order fulfillment request from a merchant in the second geographic region. The order fulfillment request may indicate a purchaser of the item in a second geographic region.

The memory 218 may also include a filtering module 240. The filtering module 240 may be configured to determine items from a plurality of eligible items based at least in part on the compliance of the item. For example, the compliance may be legal compliance of the item, product compliance of the item, an availability of the items in the second geographic region, or the category of the item, in part determined by the compliance module 244.

The filtering module 240 may also be configured to remove items that are provided by a global merchant from a list of eligible items that can be provided to a local merchant. The removed items may be ineligible to be provided or sold to local customers by the local merchant. The filtering module 240 may be configured to utilize known filtering techniques or algorithms to manage the filtering of items from a list of possible items eligible and/or available for this service.

The memory 218 may also include a user selection module 242. The user selection module 242 may be configured to determine if a merchant in a first geographic region (e.g., a global merchant) is eligible to provide one or more items to local merchants in a second geographic region. For example, this determination may include whether the merchant registered to provide items to other merchants, whether the merchant stores items in a fulfillment center associated with the system (e.g., in a first geographic region), whether the merchant provides items through a first electronic marketplace, or other determinations.

The user selection module 242 may also be configured to determine if a merchant in a second geographic region (e.g., a local merchant) is eligible to provide one or more items to local customers in the second geographic region. For example, this determination may include determining that the local merchant has acquired a high level of customer service or is associated with a rating above a rating threshold. In another example, the local merchant may have received positive feedback or provided a high level of customer service associated with previous sales. In an embodiment, looking at past performance of a merchant may serve as an incentive for local merchants to provide good service.

In another example, the local merchant may be eligible to provide the items when the local merchant has paid a particular amount of money to an escrow account or acquired insurance associated with becoming a local merchant. The escrow account or deposit of a certain amount of insurance funds may be a guarantee by the local merchant to provide a threshold level of customer service. The system may return the local merchant's funds when the local merchant meets a particular threshold rating, sells a particular dollar amount or number of items, offers a certain threshold number of items, or other instances. In an embodiment, the funds may be held in trust for the global merchant to ensure a rating threshold is met.

The user selection module 242 may also be configured to limit one or more local merchants based in part on a preference of a provider of the item. For example, the global merchant may not want local merchants located in a particular town or local merchants with a particular poor history of customer service. In another example, a qualified merchant or local merchant may be based at least in part on a preference of a provider of the item associated with a first electronic marketplace. In another example, the merchant may determine which local merchant out of five top-rated merchants can provide the item in one or more geographic regions.

The user selection module 242 may also be configured to determine a subset of qualified users. The qualified users may be local merchants, global merchants, qualified merchants, or other entities. The subset may be based at least in part on a category of an item corresponding to a category of the items offered by at least a subset of the qualified users. For example, a local merchant that only provides electronics may be limited to only providing electronics offered by a global merchant. In an embodiment, the user selection module 242 may also be configured to determine a qualified merchant of a second electronic marketplace associated with a second geographic region.

The user selection module 242 may also be configured to associate global and local geography with one or more electronic marketplaces. For example, an item may be provided by a global merchant associated with a first electronic marketplace in a first geographic region, and the item may be provided by a local merchant associated with a second electronic marketplace in a second geographic region. The first geographic region may be different from the second geographic region.

The memory 218 may also include a compliance module 244. The compliance module 244 may be configured to determine whether an item is legally compliant. For example, an item may be legally compliant when the item can be legally exported from the first geographic region and/or legally imported to the second geographic region.

The compliance module 244 may also be configured to determine whether an item is product compliant. For example, the item may include a power adapter and may be product compliant if the power adapter is compatible with the electricity available in the local geographic region (e.g., 110 volts vs. 220 volts).

The compliance module 244 may also be configured to determine whether an item is available in a second geographic region. For example, when an item has been ordered by another local merchant, the item may not need to be provided by the global merchant. In another example, the item may be exclusively offered to the local merchant and may not allow another local merchant to provide the same item.

The compliance module 244 may also be configured to determine whether an item is category compliant. For example, one or more items may be eligible to be provided by the local merchant if the local merchant already provides other items that are similar to the items that the local merchant would receive from the global merchant. This may include a local merchant that provides clothes, and the category compliant items available from the global merchant could also be limited to clothes.

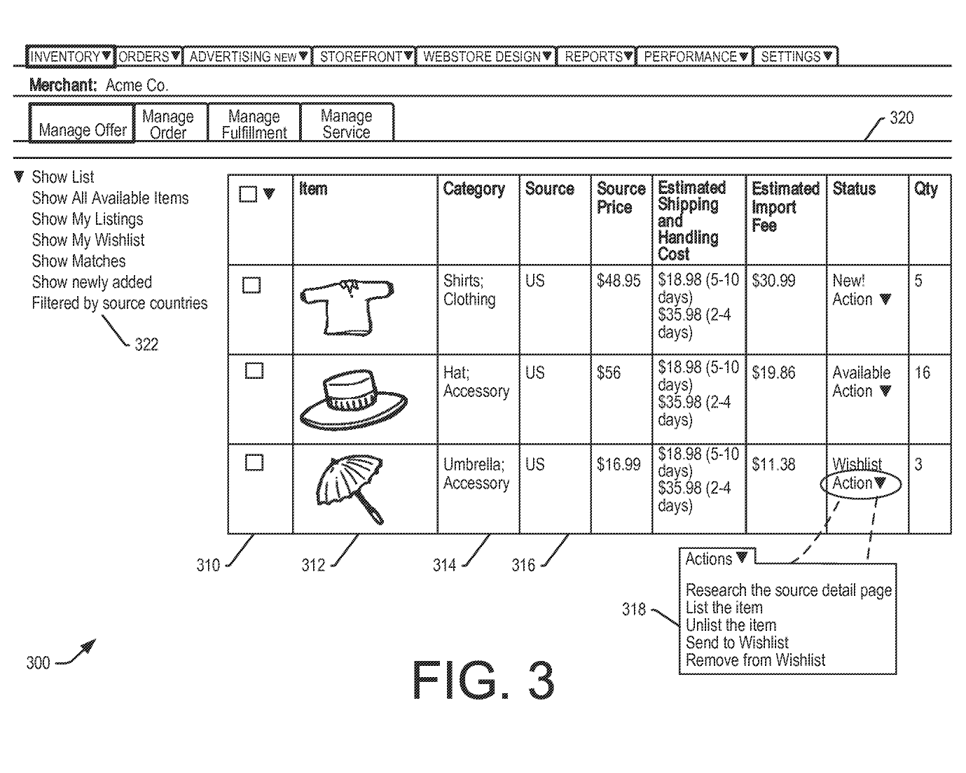

FIG. 3 illustrates an example graphical user interface for requesting an item, according to at least one example. The graphical user interface (GUI) 300 can include a selection tool 310, potential items 312 (e.g., in an image, text description, or other format), item categories 314, source geographic region 316, and other information (e.g., source price, estimated shipping and handling costs, estimated import fees, status, quantity available, etc.). The status 318 corresponding with an item can include one or more actions (e.g., research the item, list the item, remove the item from a list, send the item to a merchant's wish list to provide to customers at a later time, remove the item from a wish list, etc.) or the current status of the item (e.g., newly added to a list of potential items, available but previously added, currently on a merchant's wish list, etc.).

The GUI 300 may also include navigational tabs 320 (e.g., manage an offer, manage an order, management fulfillment, manage service, etc.) and sub-navigational tabs 322. For example, in the “manage an offer” section, the sub-navigational tabs 322 can include showing all available items, showing a merchant's listings (e.g., items available to provide to customers), showing a wish list of items (e.g., items that are not yet available to provide to customers because the merchant has not selected to provide the item to the customers), showing matches (e.g., potential items that may be available based on a set of criteria), showing newly added items, filtering items by source country (e.g., only show items from the United States), or other potential sub-sections.

In an embodiment, the local merchant may access the list of items offered by the global merchant through the GUI 300. The GUI 300 can be a management feature associated with the system. The cost of the product, estimated shipping and handling, import duty information, or other information may also be provided to the local merchant so the local merchant can generate an appropriate listing price.

The local merchant may decide to offer of an item. In an embodiment, the local merchant may request to offer the item to the local customers (e.g., by submitting a request through the navigational tabs 320 or sub-navigational tabs 322). The local merchant may select one or more items to provide to local customers using the GUI 300. For example, the local merchant can tap, select, click, or otherwise activate the selection tool 310 that corresponds with a particular potential item 312. The activation of the selection tool 310 can identify an item that the local merchant would like to provide to a corresponding geography.

In some embodiments, the activation of the selection tool 310 can interact with the service provider computers 104 or global merchant 106 to identify the source geographic region 316 or current location of the item. For example, when the local merchant selects the item, the system may determine that the item is available in the United States. The system can manage the interaction with the merchant in the United States to acquire the item for the local merchant (e.g., in India). In another example, the system may determine that the item is already available in the local geographic region. When the item is already available in the local geographic region, the local merchant may simply adjust the price, quantity, or other metrics in order to provide the item. The system may also assign ownership of the item to the local merchant instead of shipping the item to the local merchant, causing the location of the item to remain unchanged.

In some examples, the local merchant can be identified as the purchaser of the item. For example, the local merchant may become the importer of record and the customer may become the ultimate consignee at the item of entry or release of the item. The importer of record may have legal liability of the item. In another example, the local merchant may pay for shipping and/or import fees or any other fees associated with providing an item from a geographic region to the local merchant.

The service provider computers 104 or global merchant may receive one or more orders or requests for the item from local customers that purchased one or more items through the local merchant. In an embodiment, once the local customer places the order, the local merchant may receive a notification from the management computer or other entity. The local merchant may access the GUI 300 or other graphical user interface to see the order detail and/or any particular fulfillment information associated with the item.

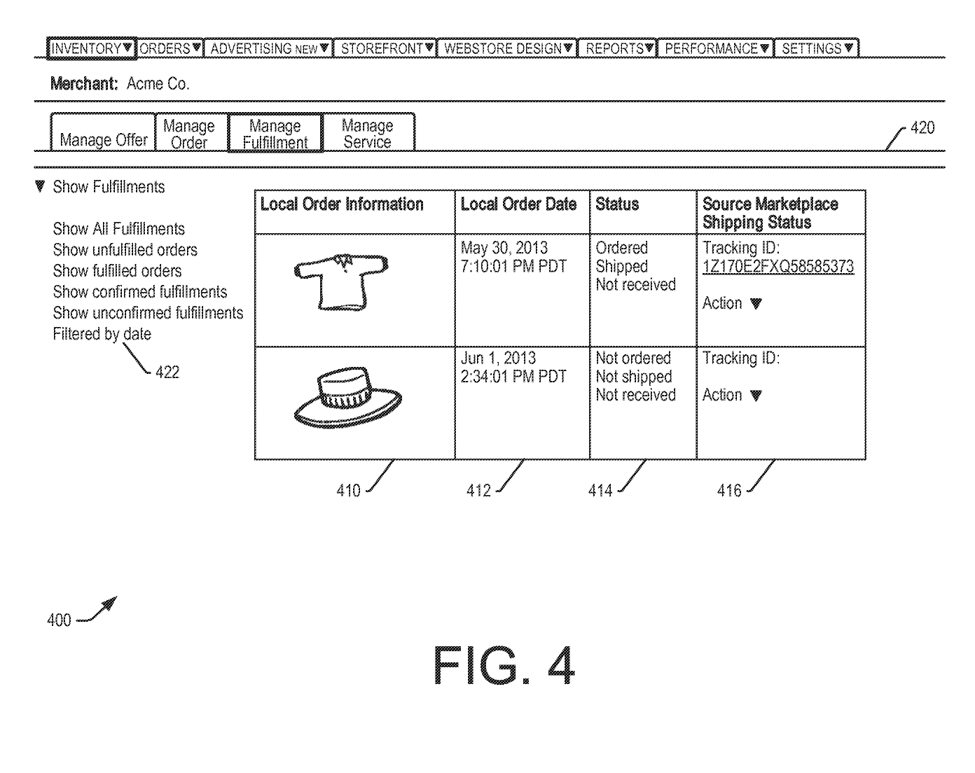

FIG. 4 illustrates an example graphical user interface for fulfilling an item, according to at least one example. The graphical user interface (GUI) 400 can include one or more requested items 410 (e.g., in an image, text description, or other format), item order dates 412, status 414, source shipping status 416, or other information associated with fulfillment, shipping, or item management. For example, after a local merchant requests one or more items, the GUI 400 may be provided to the local merchant to manage the item fulfillment.

The GUI 400 may also include navigational tabs 420 (e.g., manage an offer, manage an order, management fulfillment, manage service, etc.) that are similar to the navigational tabs 320 and sub-navigational tabs 422. For example, in the “manage a fulfillment” section, the sub-navigational tabs 422 can include showing all available fulfillments, showing unfulfilled orders, showing fulfilled orders, showing confirmed fulfillments, showing unconfirmed fulfillments, filtering the items (e.g., by date), or other potential sub-sections.

The service provider computers 104 may help manage the item fulfillment, including local order information, the date of the order, status of the order, tracking information, or other information. In an embodiment, once the local order is received, the local merchant may order the product from the global merchant (e.g., via a “Manage Fulfillment” feature). By selecting “order the product” in the management tool, the management computer may automatically help the local merchant place the order, input the local customer shipping address, and/or check out. In an embodiment, the local merchant may be registered with a customer account prior to enrolling with the management system.

The system may instruct a fulfillment service to provide the item. For example, when the item is stored with a fulfillment service in the first geography (e.g., closer to the global merchant), the system may instruct the management computer or other entity to provide the item from the fulfillment service in the first geography to a fulfillment service in a second geography (e.g., closer to the local merchant). The item may be shipped to the local fulfillment service and then provided to the local customer by the local fulfillment service. In another embodiment, the item may be provided directly to the local customer from the fulfillment service in the first geography.

In some embodiments, a graphical user interface (“GUI,” e.g., similar to GUI 400) may also be configured to assist with returning an item. For example, a customer can request to return the item from the local geographic region (e.g., the geographic region associated with the local merchant). The item may have been provided to the customer through an electronic marketplace associated with the local geographic region and/or the item request may be received through the electronic marketplace.

The item may be identified in the GUI as being provided through a second geographic region. For example, the item may have been shipped by a global merchant to a local merchant for the local merchant to offer in the local geographic region. The GUI can identify the origination of the item as the second geographic region. In some examples, the item can be identified as being provided by a first merchant in the first geographic region that received the item from a second merchant in the second geographic region.

In some examples, the GUI or service provider associated with the GUI can help determine where the returned item should be kept. For example, the item may be kept in the first geographic region (e.g., with the local merchant to resell or reoffer for sale, with a local fulfillment service or fulfillment center, etc.). The item may alternatively be returned to the global merchant or associated fulfillment center/service.

The item may be returned to a different location than the originating location. For example, the item may be provided to the local merchant from a first geographic region (e.g., the United States) to a second geographic region (e.g., India). The customer in the second geographic region can decide to return the item. The GUI or service provider associated with the GUI can determine that the item should be sent to a third geographic region (e.g., China) because the third geographic region includes a local merchant and/or customer that would like the item. The return process can identify the third geographic region and help facilitate the delivery of the item to the identified destination (e.g., creating a “mesh” of geographic locations including United States, India, China, or others).

In an embodiment, the service provider computers 104 may also provide assistance with tracking the item from the first geography to a second geography, as illustrated in status 414 and source shipping status 416. For example, when the item is returned, the GUI 400 can help identify the return date or order date of the item, the current location or status of the shipped item, the source of the returned item (e.g., the customer, the local merchant, etc.), and any shipping information (e.g., a tracking number).

In another example, the item may be returned by the customer to the local merchant (e.g., after the customer requests to return the item). The local merchant can attempt to resell or reoffer the item or negotiate with the global merchant to accept the returned item. The global merchant may determine in part if the item is not sellable or needs to be returned, repaired, or exchanged. In an embodiment, the local merchant and global merchant may negotiate during the return process, which may remove the burden of returning the item to a different geographic region from the customer.

In an embodiment, a fulfillment service may help confirm whether the item needs to be repaired or determine at what point of the fulfillment process the item became damaged (e.g., if the local merchant damaged the item, the local merchant may need to pay for the item). The item may be returned to the global merchant in order to repair. The item may appear in GUI 400 to identify where the item is in the shipping/fulfillment process and/or provide a tracking number to the merchant.

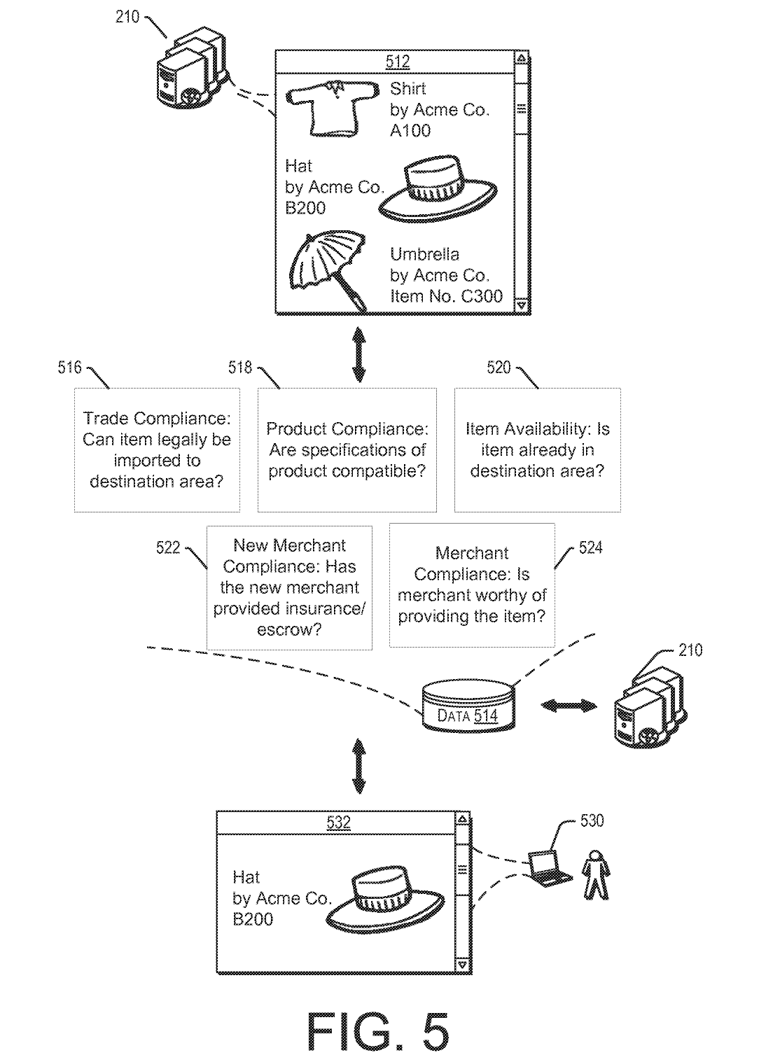

FIG. 5 illustrates an example flow diagram for determining when to offer an item, according to at least one example. For example, the item may be provided to the global merchant based in part on whether the item is allowed to be provided to the local merchant. In an embodiment, the items may be available to offer to a local merchant when the items are trade or legally compliant with local laws and regulations. This may include whether the item may be legally imported to the local geographic region (e.g., between U.S. and India).

In an embodiment, one or more items may be provided by an item management computer 210 as network content 512. For example, the items may include a shirt, a hat, and an umbrella offered in a first geographic region or offered via a first electronic marketplace. In some embodiments, the items may be provided via a GUI 300 (as shown with FIG. 3).

The item management computer 210 may interact with a data store 514 to filter the items or otherwise determine which items are eligible to be offered in a second geographic region or offered with a second electronic marketplace. For example, the items may be stored in the data store 514. The item management computer 210 can identify one or more items selected by the local merchant from the items that are stored in the data store 514. The data store 514 may review item information associated with each item.

The item management computer 210 may determine whether the item is trade or legally compliant 516 (e.g., can the item legally be imported to the destination or exported from the origin?). For example, the item management computer 210 can identify the item as a laptop and information associated with the laptop. The information may identify one or more countries that are restricted from receiving the laptop (e.g., restricted trade agreements). When the item is restricted (e.g., by model number, manufacturer, etc.), the item may not be trade or legally compliant. When the item is not restricted, the item may be trade or legally compliant and available to be provided to the local merchant.

The item management computer 210 may also determine whether the item is product compliant 518 (e.g., are the specifications of the item compatible with the destination?). For example, whether an item is product compliant may be based at least in part on standards employed in the two geographic regions. In another example, a 110 V standard may be used in one country, while a 220 V standard may be used in another country.

In some embodiments, the local merchant can confirm compliance of the item. For example, the local merchant can receive a plurality of available items that the local merchant can chose whether to offer to customers. The local merchant can filter the items that the local merchant identifies as being compliant with the geographic region (e.g., the local merchant would not select a 110 V power source when the local merchant knows that 110 V power sources do not work in the geographic region).

The item management computer 210 may also determine whether the item is available 520 (e.g., is the item already available at the destination?). For example, the geographic region can contain two local merchants. The first local merchant may order the item and return the item, causing the item to be located in a location (e.g., fulfillment center) that is within the local geographic region. The second local merchant can access the returned item from the location that is within the local geographic region instead of a location that is in a remote geographic region.

The item management computer 210 may also determine whether the merchant is new 522 (e.g., when the merchant is new, has the merchant provided insurance or contributed to an escrow account?). For example, the local merchant may not have ordered an item from the second geographic region before and may not be a trusted merchant. The local merchant can provide insurance to confirm that the local merchant will comply with a set of rule (e.g., paying the global merchant for the item, returning the item if the customer returns the item, not filing a fraudulent claim against the global merchant, etc.).

In another example, the local merchant can contribute to an escrow account. For example, the local merchant can pay the cost of receiving the item to the escrow account. When the global merchant ships the item to the local merchant, the global merchant can access the funds from the escrow account. The item management computer 210 may restrict access to the escrow account until one or more parties approve of the transfer (e.g., the local merchant may approve of the payment from the escrow account once the local merchant receives a sellable item).

The item management computer 210 may also determine whether the merchant is compliant 524 (e.g., is the merchant worthy of providing the item based in part on a rating threshold?). For example, the local merchant may be compliant when a rating associated with the local merchant exceeds a rating threshold. In another example, the global merchant may be compliant to provide items to local merchants when a rating associated with the global merchant exceeds a threshold. One or more thresholds may be applied to the compliance determination. The threshold may be unique for a particular geographic region, different based on geography, or different based on an identity of the merchant (e.g., the global merchant threshold is higher than the local merchant threshold).

When the item and/or merchant are compliant, the item may be provided to the local merchant and/or customer. In an embodiment, the item, global merchant, and/or local merchant may exceed a threshold of the combined compliance factors (e.g., each of the compliance factors passes a corresponding threshold, an average of the compliance factors passes a threshold, 3 out of 5 compliance factors passes a threshold, etc.).

When compliant, the item may be provided to the local merchant and/or local customer via a network page 532. For example, the item may be provided to the customer via user device 530 operating an application that displays the network page 532 (e.g., the customer can visit “*.cn” network page in China instead of a “*.com” network page from the United States). In some examples, the local merchant and/or local customer may operate the user device 530 to view at least a subset of items eligible to be provided in the local geographic region as network content on a network page 532.

In some examples, information associated with the item may be altered before the item is provided to the network page 532. For example, the service provider can perform a syndication of the item so that the price for the item in first geographic region matches and/or can change with the price for the item in the second geographic region (e.g., the price increases in the U.S. and also increases in India). This may help confirm that when there is a high demand for a particular item in the first geographic region and the price increases for the item, the price also increases in the second geographic region to account for the increased demand.

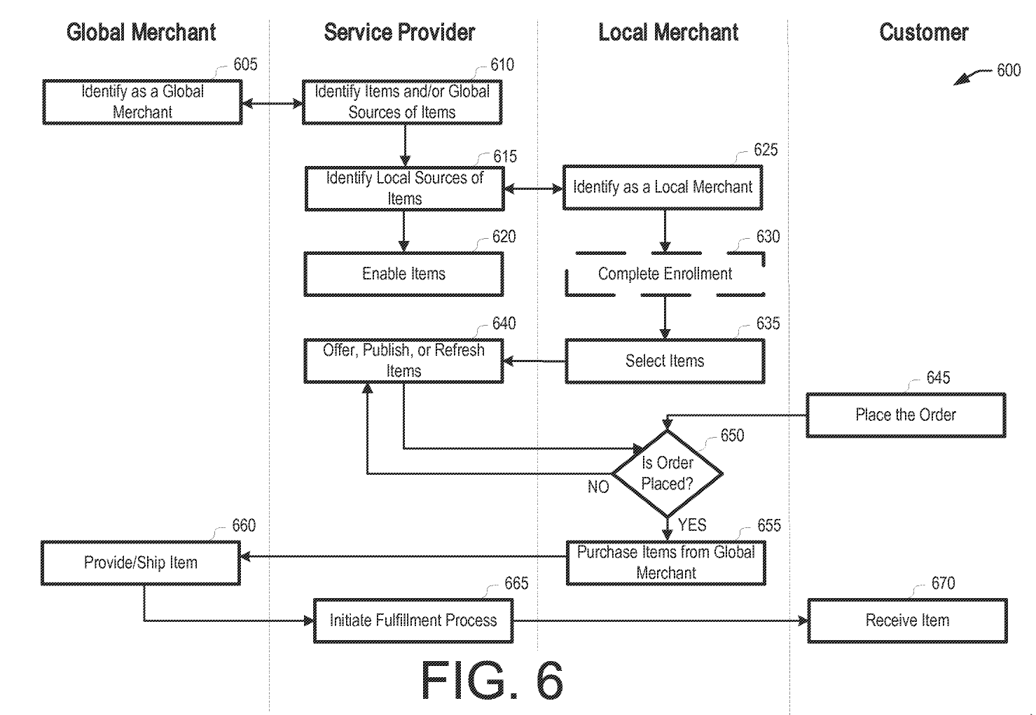

FIG. 6 illustrates an example flow diagram for providing a global merchant network, according to at least one example. In some examples, the one or more item management computers 210 (e.g., utilizing at least one of the item information module 236, the inventory module 238, the filtering module 240, the user selection module 242, and/or the compliance module 244) or one or more user devices 204 shown in FIG. 2 may perform the process 600 of FIG. 6. In some embodiments, the item management computers 210 or service provider computers 104 may perform the functions of a “service provider” and the global merchant, the local merchant, and customer may operate one or more user devices 204.

The process 600 may begin at 605 when a global merchant is identified as a global merchant. The global merchant may log in or otherwise identify an entity as a merchant that is willing to provide items to other merchants. In some examples, the global merchant may qualify as a global merchant (e.g., based on user feedback, based on amount of annual sales, etc.) or satisfy compliance standards for becoming a global merchant.

At 610, the service provider can identify items and/or global sources of items. For example, the service provider can identify one or more global merchants as global sources of items. The service provider may also identify the items that the global merchants provide to the service provider, local merchant, and/or customers.

At 615, the service provider can identify the local sources of items. For example, when an item is available from a global merchant, the service provider can identify the global provider as a source of the item. In another example, when the item is available in a fulfillment center that is local to a local merchant, the service provider can identify the fulfillment center as a source of the item.

At 620, the service provider can enable the items. For example, the service provider can allow the items to be displayed on a GUI 300. In another example, the service provider can allow the items to be identified by other entities, including the local merchant and/or the customer.

At 625, the local merchant can identify as a local merchant. For example, the local merchant may notify the service provider that the local merchant would like to provide items in a particular geographic region. In some examples, the local merchant may qualify as a local merchant (e.g., based on user feedback, based on amount of annual sales in the local geography, etc.).

At 630, the local merchant may optionally complete an enrollment process. In some examples, the enrollment process may not be needed in order for the local merchant to provide items to the local geographic region. The enrollment process can include completing terms and conditions or other contractual agreements and/or registering for an account on a network page.

At 635, the local merchant may select items. For example, the local merchant may log in or otherwise identify an entity as a merchant that is willing to receive items from a global merchant and/or local fulfillment center, and provide those items to local customers. The local merchant can associate information with the item, including a price, description, shipping duration, or other information that may be helpful to a customer when the customer is determining whether to place an order with the local merchant.

In some examples, the local merchant can sell or offer the items to the customer at a price that is different than the price that the global merchant offers the item. The price may include any additional cost that the local merchant incurs by providing the item in the local geographic region, markups from the global merchant, or taxes (e.g., value added tax (VAT), import tax, etc.). The price may also include a reduced price in comparison with the price from the global merchant (e.g., in order to stay competitive with other merchants in the area). In some examples, the global merchant can set ranges and/or limits for the price of the item offered in the local geographic region by the local merchant.

At 640, the service provider can offer, publish, or refresh items. For example, the service provider may display the items for a customer on behalf of the local merchant. The display can include the items that are identified by the local merchant or any additional information associated with the item that the local merchant identified. When new items are added by the local merchant and/or global merchant, the list of items can be updated.

At 645, the customer can place an order. For example, the customer may browse to a network page by operating a user device and select one or more items that the customer would like to purchase from the local merchant. In some examples, the customer can login to the network page by providing credentials and place the order by providing payment information (e.g., or adding the item to a wish list, paying for an item with a gift card, bidding and winning an auction for an item, etc.).

At 650, the local merchant can determine whether an order was placed. In some examples, the service provider can determine whether the order was placed on behalf of the local merchant. The determination may identify whether a customer submitted an order through a network page. If no, the process 600 can return to 640 to offer, publish, or refresh items. If yes, the process 600 can proceed to 655.

At 655, the local merchant can purchase the item from the global merchant. In some examples, the service provider can facilitate the interaction between the local merchant and global merchant to ensure that the item are purchased and shipped. The local merchant may be a customer of the global merchant (e.g., a business-to-business transaction).

At 660, the global merchant can provide/ship the item. For example, the global merchant can accept payment for the item in a business-to-business transaction and ship the item to the local merchant. In some examples, the item can be shipped from the global merchant to the local merchant, so that the local merchant is the importer of record. In another example, the local merchant may be the “sold to” party and the customer may be the “ship to” party on a commercial invoice.

At 665, the service provider can initiate a fulfillment process. For example, the service provider can receive the item from the global merchant on behalf of the local merchant. The service provider can receive the item at a fulfillment center (e.g., located in a particular geographic region, located close to the global merchant or local merchant, etc.) and/or using a fulfillment service. The fulfillment process may include one or more steps of a standard fulfillment process without diverting from the essence of the disclosure.

At 670, the customer may receive the item. For example, the customer can receive the item from a fulfillment center, fulfillment server, and/or local merchant. The customer may interact with the local merchant instead of the global merchant when the customer has questions about their order, would like to return their order, or other instances when the customer may want to interact with a merchant.

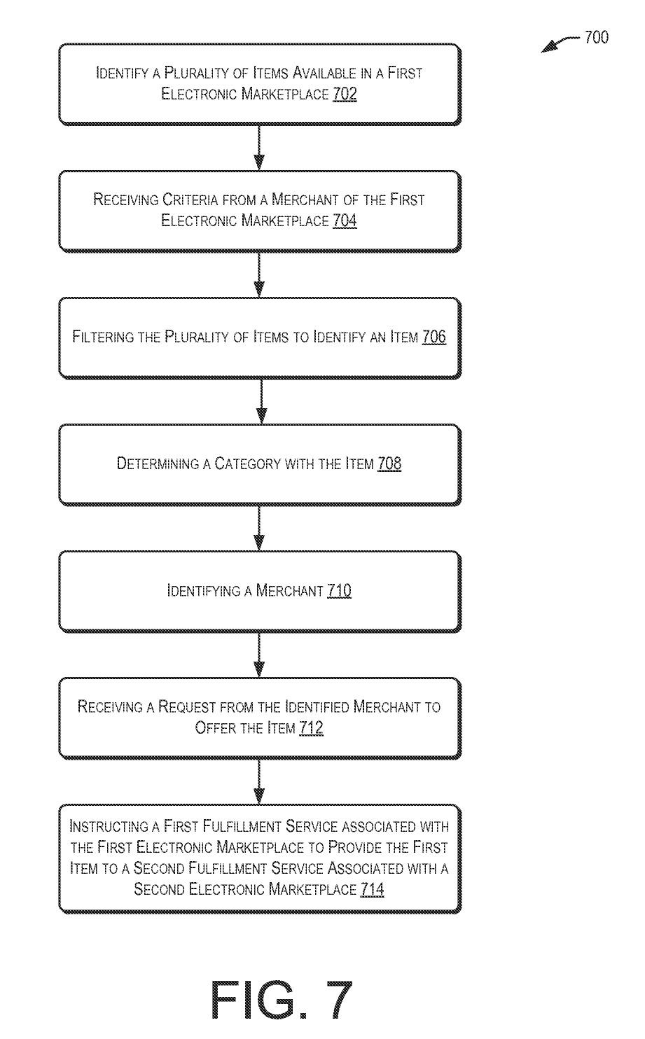

FIG. 7 illustrates an example flow diagram for providing a global merchant network, according to at least one example. In some examples, the one or more item management computers 210 (e.g., utilizing at least one of the item information module 236, the inventory module 238, the filtering module 240, the user selection module 242, and/or the compliance module 244) or one or more user devices 204 shown in FIG. 2 may perform the process 700 of FIG. 7. The process 700 may begin at 702 by identifying a plurality of items available in a first electronic marketplace. At 704, the process 700 may include receiving criteria from a merchant of the first electronic marketplace. For example, the criteria can identify other users of a second marketplace to whom the merchant is willing to offer the plurality of items. At 706, the process 700 may include filtering the plurality of items to identify an item. For example, the filtering can be implemented by one or more computer systems. The filtering can identify a first item of the plurality of items that is eligible to be offered in the second electronic marketplace. At 708, the process 700 may include determining a category with the item. For example, the category can be associated with the first item when the first item is not already offered in the second electronic marketplace. At 710, the process 700 may include identifying a merchant. For example, the merchant of the other users of the second electronic marketplace can offer at least a second item corresponding to the determined category. At 712, the process 700 may include receiving a request from the identified merchant to offer the item. For example, the request from the identified merchant can be to offer the first item to customers of the second electronic marketplace. Further in some examples, the process 700 may end at 714, where the process 700 may include instructing a first fulfillment service associated with the first electronic marketplace to provide the first item to a second fulfillment service associated with a second electronic marketplace.

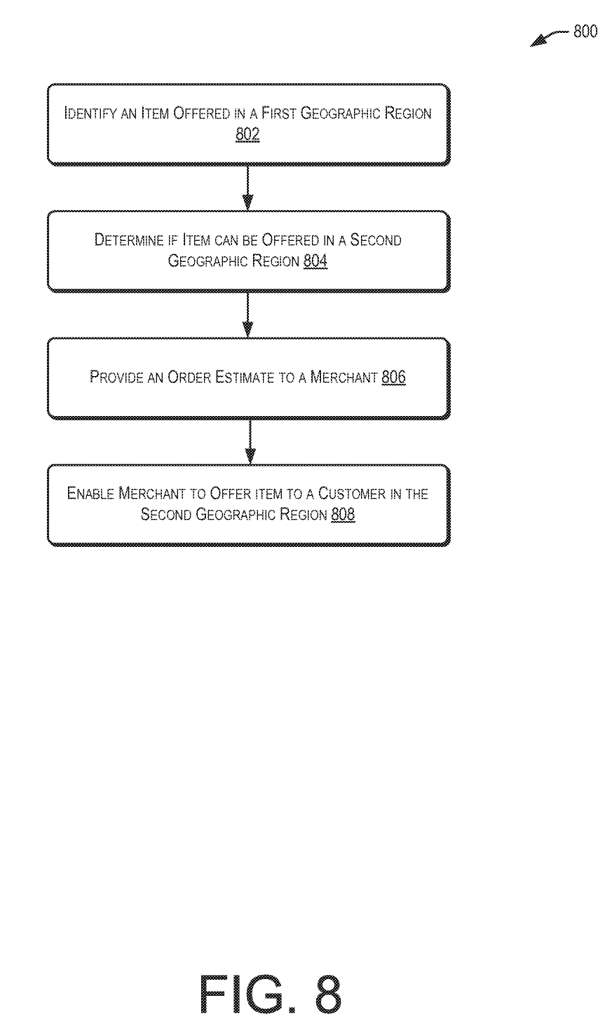

FIG. 8 illustrates an example flow diagram for providing a global merchant network, according to at least one example. In some examples, the one or more item management computers 210 (e.g., utilizing at least one of the item information module 236, the inventory module 238, the filtering module 240, the user selection module 242, and/or the compliance module 244) or one or more user devices 204 shown in FIG. 2 may perform the process 800 of FIG. 8. The process 800 may begin at 802 by identifying an item offered in a first geographic region. For example, the first geographic region may be associated with a first electronic marketplace, so that the item offered in the first geographic region is available in the first electronic marketplace. At 804, the process 800 may include determining if the item can be offered in a second geographic region. For example, the determination can include determining if the item can be offered to qualified merchants of a second geographic region based at least in part on information associated with an identifier of the item and a preference of a provider of the item. If it is determined that the item can be offered to the qualified merchants, the process can proceed to 806. At 806, the process 800 may include providing an order estimate to a user. For example, the order estimate can be provided to at least a subset of the qualified merchants. Further in some examples, the process 800 may end at 808, where the process 800 may include enabling the merchant to offer the item to a customer in the second geographic region. For example, the enablement can include at least one of the subset of the qualified merchants to offer the item to a customer of the second geographic region when the at least one of the subset of qualified merchants accepts the order estimate.

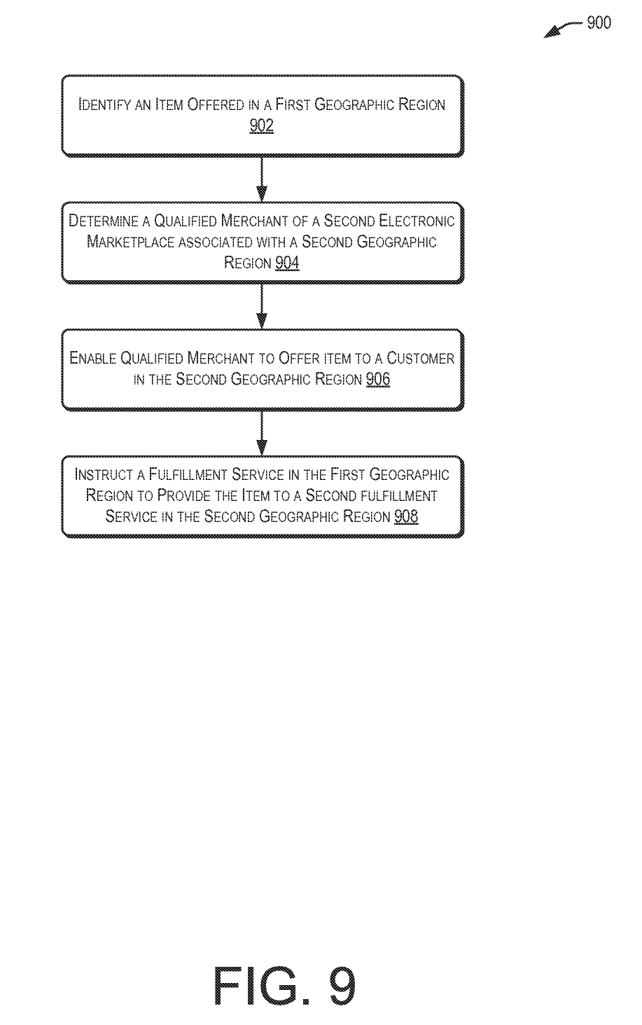

FIG. 9 illustrates an example flow diagram for providing a global merchant network, according to at least one example. In some examples, the one or more item management computers 210 (e.g., utilizing at least one of the item information module 236, the inventory module 238, the filtering module 240, the user selection module 242, and/or the compliance module 244) or one or more user devices 204 shown in FIG. 2 may perform the process 900 of FIG. 9. The process 900 may begin at 902 by identifying an item offered in a first geographic region. For example, the identified item can be offered in a first electronic marketplace associated with the first geographic region. At 904, the process 900 may include determining a qualified merchant of a second electronic marketplace associated with a second geographic region. At 906, the process 900 may include enabling the qualified merchant to offer the item to a customer in the second geographic region. For example, the qualified merchant may be enabled to offer the item to a customer of the second geographic region when it is determined that the item is not available in a catalog of the second electronic marketplace. Further in some examples, the process 900 may end at 908, where the process 900 may include instructing a fulfillment service in the first geographic region to provide the item to a second fulfillment service in the second geographic region. For example, the first fulfillment service may be associated with the first electronic marketplace and the second fulfillment service may be associated with the second electronic marketplace. In some examples, the item can be offered through a graphical user interface (GUI) that allows the customer to request the item from the qualified merchant.

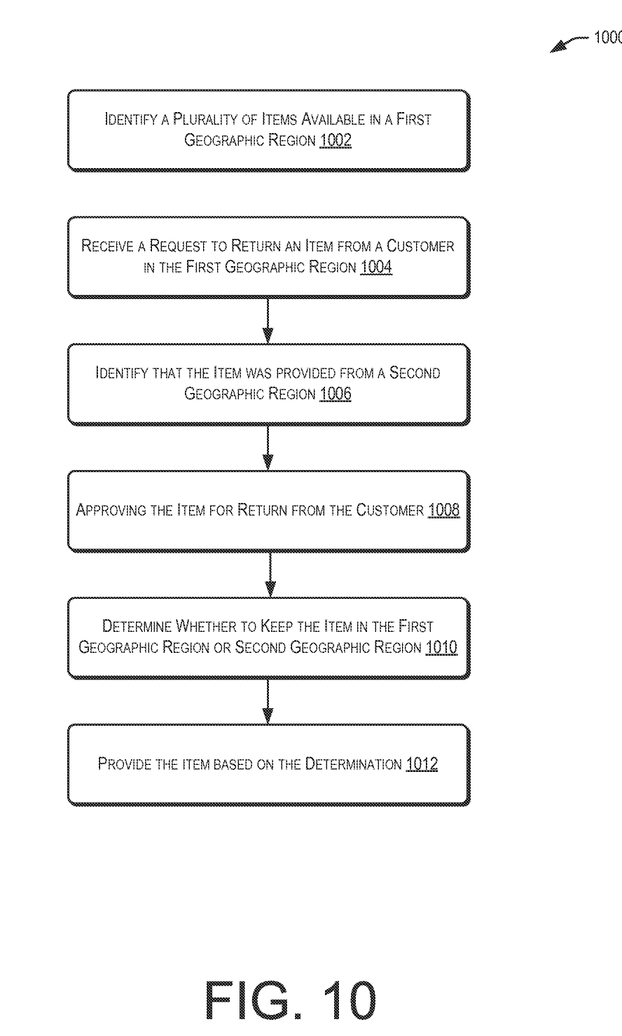

FIG. 10 illustrates an example flow diagram for providing a global merchant network, according to at least one example. In some examples, the one or more item management computers 210 (e.g., utilizing at least one of the item information module 236, the inventory module 238, the filtering module 240, the user selection module 242, and/or the compliance module 244) or one or more user devices 204 shown in FIG. 2 may perform the process 1000 of FIG. 10. The process 1000 may begin at 1002 by identifying a plurality of items available in a first geographic region. For example, the plurality of items may be available in a first electronic marketplace for the first geographic region. At 1004, the process 1000 may include receiving a request to return an item from a customer in a first geographic region. For example, the item may have been provided to a customer through the first electronic marketplace for the first geographic region. At 1006, the process 1000 may include identifying that the item was provided from a second geographic region. At 1008, the process 1000 may include approving the item for return from the customer. At 1010, the process 1000 may include determining whether to keep the item in the first geographic region or second geographic region. For example, the determination can include determining whether to keep the item with the first geographic region or return the item to the second geographic region. Further in some examples, the process 1000 may end at 1012, where the process 1000 may include shipping the item based on the determination. For example, when the determination is made to return the item to the second geographic region, the item maybe provided to the second geographic region. In some examples, the item may be shipped in order to provide the item to the second geographic region.

Illustrative methods and systems for providing recommended items are described above. Some or all of these systems and methods may, but need not, be implemented at least partially by architectures such as those shown at least in FIGS. 1-10 above.

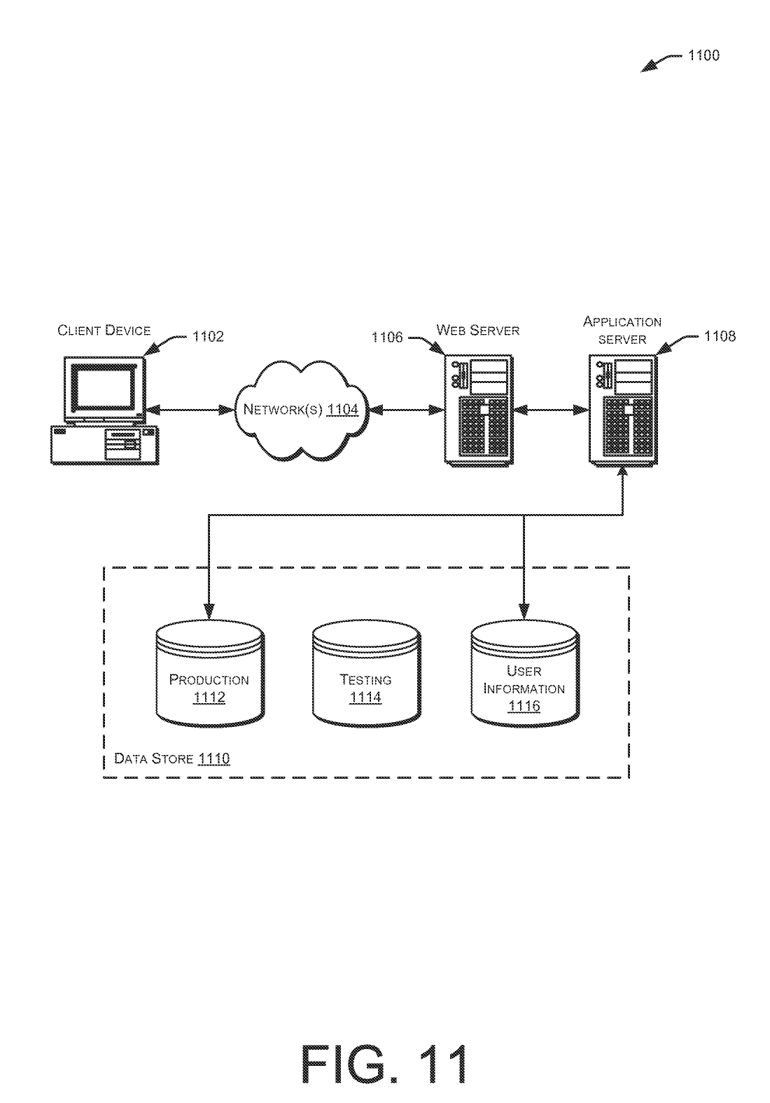

FIG. 11 illustrates aspects of an example environment 1100 for implementing aspects in accordance with various embodiments. As will be appreciated, although a Web-based environment is used for purposes of explanation, different environments may be used, as appropriate, to implement various embodiments. The environment includes an electronic client device 1102, which can include any appropriate device operable to send and receive requests, messages, or information over an appropriate network 1104 and convey information back to a user of the device. Examples of such client devices include personal computers, cell phones, handheld messaging devices, laptop computers, set-top boxes, personal data assistants, electronic book readers, and the like. The network can include any appropriate network, including an intranet, the Internet, a cellular network, a local area network or any other such network or combination thereof. Components used for such a system can depend at least in part upon the type of network and/or environment selected. Protocols and components for communicating via such a network are well known and will not be discussed herein in detail. Communication over the network can be enabled by wired or wireless connections and combinations thereof. In this example, the network includes the Internet, as the environment includes a Web server 1106 for receiving requests and serving content in response thereto, although for other networks an alternative device serving a similar purpose could be used as would be apparent to one of ordinary skill in the art.

The illustrative environment includes at least one application server 1108 and a data store 1110. It should be understood that there can be several application servers, layers, or other elements, processes or components, which may be chained or otherwise configured, which can interact to perform tasks such as obtaining data from an appropriate data store. As used herein the term “data store” refers to any device or combination of devices capable of storing, accessing, and/or retrieving data, which may include any combination and number of data servers, databases, data storage devices and data storage media, in any standard, distributed or clustered environment. The application server can include any appropriate hardware and software for integrating with the data store as needed to execute aspects of one or more applications for the client device, handling a majority of the data access and business logic for an application. The application server provides access control services in cooperation with the data store, and is able to generate content such as text, graphics, audio and/or video to be transferred to the user, which may be served to the user by the Web server in the form of HTML, XML or another appropriate structured language in this example. The handling of all requests and responses, as well as the delivery of content between the client device 1102 and the application server 1108, can be handled by the Web server. It should be understood that the Web and application servers are not required and are merely example components, as structured code discussed herein can be executed on any appropriate device or host machine as discussed elsewhere herein.

The data store 1110 can include several separate data tables, databases or other data storage mechanisms and media for storing data relating to a particular aspect. For example, the data store illustrated includes mechanisms for storing production data 1112 and user information 1116, which can be used to serve content for the production side. The data store also is shown to include a mechanism for storing log data 1114, which can be used for reporting, analysis, or other such purposes. It should be understood that there can be many other aspects that may need to be stored in the data store, such as for page image information and to access right information, which can be stored in any of the above listed mechanisms as appropriate or in additional mechanisms in the data store 1110. The data store 1110 is operable, through logic associated therewith, to receive instructions from the application server 1108 and obtain, update or otherwise process data in response thereto. In one example, a user might submit a search request for a certain type of item. In this case, the data store might access the user information to verify the identity of the user, and can access the catalog detail information to obtain information about items of that type. The information then can be returned to the user, such as in a results listing on a web page that the user is able to view via a browser on the user device 1102. Information for a particular item of interest can be viewed in a dedicated page or window of the browser.

Each server typically will include an operating system that provides executable program instructions for the general administration and operation of that server, and typically will include a computer-readable storage medium (e.g., a hard disk, random access memory, read only memory, etc.) storing instructions that, when executed by a processor of the server, allow the server to perform its intended functions. Suitable implementations for the operating system and general functionality of the servers are known or commercially available, and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 11. Thus, the depiction of the system 1100 in FIG. 11 should be taken as being illustrative in nature, and not limiting to the scope of the disclosure.

The various embodiments further can be implemented in a wide variety of operating environments, which in some cases can include one or more user computers, computing devices or processing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems and other devices capable of communicating via a network.

Most embodiments utilize at least one network that would be familiar to those skilled in the art for supporting communications using any of a variety of commercially-available protocols, such as TCP/IP, OSI, FTP, UPnP, NFS, CIFS, and AppleTalk®. The network can be, for example, a local area network, a wide-area network, a virtual private network, the Internet, an intranet, an extranet, a public switched telephone network, an infrared network, a wireless network, and any combination thereof.

In embodiments utilizing a Web server, the Web server can run any of a variety of server or mid-tier applications, including HTTP servers, FTP servers, CGI servers, data servers, Java servers, and business application servers. The server(s) also may be capable of executing programs or scripts in response requests from user devices, such as by executing one or more Web applications that may be implemented as one or more scripts or programs written in any programming language, such as Java®, C, C# or C++, or any scripting language, such as Perl, Python or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen or keypad), and at least one output device (e.g., a display device, printer or speaker). Such a system may also include one or more storage devices, such as disk drives, optical storage devices, and solid-state storage devices such as RAM or ROM, as well as removable media devices, memory cards, flash cards, etc.

Such devices also can include a computer-readable storage media reader, a communications device (e.g., a modem, a network card (wireless or wired), an infrared communication device, etc.) and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Storage media and computer-readable media for containing code, or portions of code, can include any appropriate media known or used in the art, including storage media and communication media, such as but not limited to volatile and non-volatile, removable and non-removable media implemented in any method or technology for storage and/or transmission of information such as computer-readable instructions, data structures, program modules or other data, including RAM, ROM, EEPROM, flash memory or other memory technology, CD-ROM, DVD, or other optical storage, magnetic cassettes, magnetic tape, magnetic disk storage or other magnetic storage devices or any other medium which can be used to store the desired information and which can be accessed by the a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as that included in the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, and/or at least one of Z in order for each to be present.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A computer-implemented method, comprising:
identifying a plurality of items available in a first electronic marketplace;
receiving criteria from a merchant of the first electronic marketplace, the criteria identifying users of a second electronic marketplace to whom the merchant is willing to offer at least one of the plurality of items;
filtering, by one or more computer systems, the plurality of items to identify a first item of the plurality of items that is eligible to be offered in the second electronic marketplace;
determining a category associated with the first item if the first item is not already offered in the second electronic marketplace;
identifying a second merchant of the second electronic marketplace that offers, to the users of the second electronic marketplace, at least a second item corresponding to the determined category;
receiving a request from the identified second merchant to offer the first item to the users of the second electronic marketplace; and
instructing, by the one or more computer systems, a first fulfillment service associated with the first electronic marketplace to provide the first item to a second fulfillment service associated with the second electronic marketplace at least in response to receiving the request from the identified second merchant.

2. The computer-implemented method of claim 1, wherein the filtering comprises at least removing items from the plurality of items based at least in part on at least one of legal compliance of the items, product compliance of the items, an availability of the items in the second electronic marketplace, or the category of the items.

3. The computer-implemented method of claim 1, wherein the first electronic marketplace is associated with a first geographic region and the second electronic marketplace is associated with a second geographic region different from the first geographic region.

4. The computer-implemented method of claim 3, wherein first items provided in the first geographic region are identified in a first language and second items provided in the second geographic region are identified in a second language different from the first language.

5. The computer-implemented method of claim 1, further comprising:
identifying a first price for the first item in the first electronic marketplace and a second price for the first item in the second electronic marketplace;
receiving a price update for the first item in the first electronic marketplace; and
updating the second price of the first item in the second electronic marketplace based at least in part on the received price update.

6. The computer-implemented method of claim 1, further comprising determining a profitability associated with providing the plurality of items in the first electronic marketplace.

7. A system, comprising:
a memory that stores computer-executable instructions; and
a processor device configured to access the memory, the processor device configured to execute the computer-executable instructions to collectively at least:
identify an item offered in a first geographic region through a first electronic marketplace;
determine if the item can be offered by qualified merchants of a second geographic region through a second electronic marketplace based at least in part on information associated with an identifier of the item and a preference of a provider of the item, the provider of the item associated with the first electronic marketplace; and
if it is determined that the item can be offered by the qualified merchants:
provide an order estimate to at least a subset of the qualified merchants; and
enable at least one of the subset of the qualified merchants to offer the item to a customer of the second geographic region through the second electronic marketplace if the at least one of the subset of qualified merchants accepts the order estimate.

8. The system of claim 7, wherein it is determined that the item can be offered by the qualified merchants of the second geographic region if the information associated with the item indicates at least one of that the item is not offered in the second geographic region, that the item complies with import regulations of the second geographic region, or that the item complies with product standards of the second geographic region.

9. The system of claim 7, wherein it is determined that the item can be offered by the qualified merchants of the second geographic region when the preference of the provider of the item identifies a rating threshold and the qualified merchants have ratings above the rating threshold.

10. The system of claim 7, wherein the at least a subset of the qualified merchants is determined based at least in part on a category of the item corresponding to a category of other items offered by the at least a subset of the qualified merchants.

11. The system of claim 7, wherein the order estimate comprises at least one of a cost of the item from the provider of the item, a customs expense, a shipping expense, or a tax associated with providing the item from the first geographic region to the second geographic region.

12. The system of claim 7, wherein the processor device is further configured to execute the computer-executable instructions to collectively at least enable a return of the item to the first geographic region if at least one of the customers of the second geographic region requests to return the item.

13. The system of claim 7, wherein the item is enabled to be offered to the customer of the second geographic region based at least in part on providing instructions to a first fulfillment center in the first geographic region to ship the item to a second fulfillment center in the second geographic region.

14. The system of claim 13, wherein the qualified merchants are sellers in the second geographic region associated with the first electronic marketplace that services the first geographic region or the second electronic marketplace that services the second geographic region.

15. The system of claim 14, wherein the processor device is further configured to execute the computer-executable instructions to collectively at least provide instructions to the second fulfillment center to ship the item to a purchaser of the item at least in response to an order fulfillment request from at least one of the merchants in the second geographic region.

16. The system of claim 14, wherein the processor device is further configured to execute the computer-executable instructions to collectively at least provide instructions to the second fulfillment center to ship the item to at least one of the merchants in the second geographic region at least in response to an order fulfillment request from at least one of the merchants in the second geographic region, the order fulfillment request indicating a purchaser of the item in the second geographic region.

17. One or more computer-readable storage devices collectively storing computer-executable instructions that, when executed by one or more computer systems, configure the one or more computer systems to collectively perform operations comprising:
identifying a first item offered by a first merchant in a first geographic region through a first electronic marketplace;
identifying a second merchant of a second electronic marketplace that offers a second item of a same category as the first item, the second electronic marketplace associated with a second geographic region;
enabling the second merchant to offer the item to a customer of the second geographic region if it is determined that the item is not available in a catalog of the second electronic marketplace; and
instructing a first fulfillment service associated with the first electronic marketplace to provide the first item to a second fulfillment service associated with the second electronic marketplace.

18. The computer-readable storage device of claim 17, wherein the second merchant is identified based at least in part on a preference of the first merchant.

19. The computer-readable storage device of claim 17, wherein the item is offered through a graphical user interface that allows the customer to request the item from the second merchant.

20. A computer-implemented method comprising:
identifying a plurality of items available in a first electronic marketplace for a first geographic region;
receiving, by one or more computer systems, a request to return an item from a customer in the first geographic region, the item included in the plurality of items, and the item provided to a customer through the first electronic marketplace for the first geographic region;
identifying, by the one or more computer systems, that the item was provided to the first electronic marketplace from a second electronic marketplace of a second geographic region;
determining, by the one or more computer systems, whether to keep the item with the first geographic region or return the item to the second geographic region; and
providing the item to the second geographic region if it is determined to return the item to the second geographic region.

21. The method of claim 20, wherein the item was previously provided, to the customer, by a first merchant in the first geographic region that received the item from a second merchant in the second geographic region.

22. The method of claim 21, wherein the second merchant in the second geographic region is a qualified merchant based in part on a rating threshold.

23. The method of claim 21, wherein the first merchant qualified for providing the item, to the customer, by providing a particular amount of money to an escrow account or acquiring insurance associated with becoming the first merchant.
